(19) United States
(12) Patent Application Publication
(10) Pub. No.: US 2026/0303268 A1
(43) Pub. Date: Oct. 1, 2026

(54) RETRANSMISSION IN WIRELESS COMMUNICATIONS OF OUTDATED SERVICE DATA UNIT

(71) Applicant: Sharp Kabushiki Kaisha, Sakai City (JP)

(72) Inventors: Sangkyu BAEK, Vancouver, WA (US); Atsushi ISHII, Vancouver, WA (US); Tomoki YOSHIMURA, Camas, WA (US); Zhanping YIN, Vancouver, WA (US)

(21) Appl. No.: 19/091,971

(22) Filed: Mar. 27, 2025

(51) Int. Cl. H04L 1/1867; H04L 1/1812; H04L 5/00; H04W 72/21

(52) U.S. Cl. CPC H04L 1/188; H04L 5/0055; H04W 72/21; H04L 1/1812

(57) ABSTRACT

A network node of a telecommunications system comprises processor circuitry and interface circuitry. The processor circuitry is configured to make a first determination that a poll retransmit timer has expired; to make a second determination regarding packet availability for transmission or retransmission; and to make a third determination to retransmit an outdated packet of a predetermined type in dependence upon the first determination and the second determination. The interface circuitry is configured to retransmit the outdated packet over a radio interface to another node in accordance with the third determination.

### TECHNICAL FIELD

The technology relates to wireless communications, and particularly to retransmission of packets and/or delay status reporting in a wireless communications system.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a communications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

The Open Systems Interconnection, OSI, model is a reference framework that explains the process of transmitting data between computers. It is divided into seven layers that work together to carry out specialized network functions, allowing for a more systematic approach to networking. Information transferred from one device to another device travels through 7 layers of OSI model. First data travels down through 7 layers from the sender's end and then climbs back 7 layers on the receiver's end. Data flows through the OSI model in a step-by-step process:
Layer 7: Application Layer: Applications create the data.
Layer 6: Presentation Layer: Data is formatted and encrypted.
Layer 5: Session Layer: Connections are established and managed.
Layer 4: Transport Layer: Data is broken into segments for reliable delivery.
Layer 3: Network Layer: Segments are packaged into packets and routed.
Layer 2: Data Link Layer: Packets are framed and sent to the next device.
Layer 1: Physical Layer: Frames are converted into bits and transmitted physically.

A protocol stack may comprise different individual protocols. Protocols may be simply described as a set of rules that allow communication between peer entities or they can also be described as a set of rules that facilitate horizontal communication. These protocols may be arranged in the layers such as those described above. In a transmitter side, a layer N receives data from layer N+1 and this data is called the SDU or Service Data Unit. This layer will modify the data and convert it into a PDU or a Protocol Data Unit. The peer entity in the receiver is only able to understand this PDU. In the receiver side, the peer entity receives the PDU from layer N−1, e.g., actually layer N−1 SDU, and converts it back into SDU(s) and passes it to layer N+1.

Radio Link Control (RLC) is a layer 2 Radio Link Protocol used in UMTS, LTE and 5G on the Air interface. This protocol is specified by 3GPP in TS 25.322 for UMTS, TS 36.322 for LTE and TS 38.322 for 5G New Radio (NR). RLC is located on top of the 3GPP MAC-layer and below the packet data convergence protocol (PDCP) layer. The main tasks of the RLC protocol are:
Transfer of upper layer Protocol Data Units (PDUs) in one of three modes: Acknowledged Mode (AM), Unacknowledged Mode (UM) and Transparent Mode (TM)
Error correction through ARQ (only for AM data transfer)
Segmentation and reassembly of RLC SDUs (UM and AM)
Re-segmentation of RLC data PDUs (AM)
Reordering of RLC data PDUs (UM and AM)
Duplicate detection (UM and AM)
RLC SDU discard (UM and AM)
RLC re-establishment
Protocol error detection and recovery

The Radio Resource Control (RRC) plays a role in managing the radio resources between the User Equipment (UE) and the 5G New Radio (NR) network. The major functions of the RRC protocol include connection establishment and release functions, broadcast of system information, radio bearer establishment, reconfiguration and release, RRC connection mobility procedures, paging notification and release and outer loop power control. By means of the signaling functions the RRC configures the user and control planes according to the network status and allows for Radio Resource Management strategies to be implemented.

The Medium Access Control layer plays a role in managing radio resources and ensuring efficient communication within networks. It operates just above the physical layer (PHY) and below the radio link control (RLC) and the packet data convergence protocol (PDCP) layers. The medium access control (MAC) is the layer that controls the hardware responsible for interaction with the wired or wireless transmission medium. The MAC sublayer and the logical link control (LLC) sublayer together make up the data link layer. The LLC provides flow control and multiplexing for the logical link, while the MAC provides flow control and multiplexing for the transmission medium. These two sublayers together correspond to layer 2 of the OSI model. Functions performed by the MAC layer include the following:
Resource Allocation: The MAC layer allocates resources (e.g., time, frequency, and code resources) to connected user equipment (UEs) to facilitate efficient data transmission.
Scheduling: It determines which UEs can transmit data and when, taking into account various factors like Quality of Service (QoS) requirements, traffic types, and channel conditions.
HARQ (Hybrid Automatic Repeat reQuest): The MAC layer handles HARQ processes, enabling retransmissions of data packets in case of errors.
Logical Channels: It manages logical channels for control information exchange between the MAC layer and higher-layer protocols.
Multiplexing and De-Multiplexing: MAC layer multiplexes and de-multiplexes data flows from different UEs onto the shared radio resources.
PDCCH (Physical Downlink Control Channel): MAC plays a role in the allocation and signaling of PDCCH resources for control information transmission.
User Plane and Control Plane MAC Functions: MAC functions are divided into User Plane (UP) and Control Plane (CP) categories, each serving specific purposes. The UP MAC manages the transmission and reception of user data, while the CP MAC handles control signaling and coordination between the UE and the network.

Thus, functions performed by the MAC layer include:
Frame delimiting and recognition
Addressing of destination stations (both as individual stations and as groups of stations)
Conveyance of source-station addressing information
Transparent data transfer of LLC PDUs, or of equivalent information in the Ethernet sublayer
Protection against errors, generally by means of generating and checking frame check sequences
Control of access to the physical transmission medium

A RRC is in control of the MAC configuration. A MAC entity of a wireless terminal serves many functions, including handling the following transport channels:
Broadcast Channel (BCH)
Downlink Shared Channel(s) (DL-SCH)
Paging Channel (PCH)
Uplink Shared Channel(s) (UL-SCH)
Random access channel(s) (RACH).

The access stratum, AS, is a functional layer in protocol stacks between a radio network and user equipment. The access stratum is responsible, e.g., for transporting data over the wireless connection and managing radio resources.

Wireless communication systems typically utilize retransmission, e.g., the resending of packets which have been either damaged or lost. Retransmission is one of the basic mechanisms used to provide more reliable communication. Retransmission can be implemented in various ways and may be occasion, interject, involve, or be associated with various problems.

### First Problem: An Autonomous Retransmission Triggered Before the Initial Transmission.

In the 3GPP NR, New Radio, RLC, Radio Link Control, AM, Acknowledged Mode, a transmitter may perform a retransmission of packet called RLC SDU, Service Data Unit, or SDU segment, upon reception of negative acknowledgement, NACK, from the receiver. The RLC NACK is included in an RLC status report which may be a RLC control PDU, Protocol Data Unit. The RLC status report may experience transmission delay due to a HARQ, Hybrid Automatic Repeat Request, retransmission. The RLC retransmission mechanism relying on RLC status report may delay retransmission. In uplink transmission from a wireless terminal, UE, to its connected network node, e.g., gNB, the transmitter can be a UE and the receiver can be the gNB.

3GPP NR Release 19 (Rel-19) standards introduced an autonomous retransmission mechanism in which the transmitter performs a retransmission without receiving negative acknowledgement in RLC AM. FIG. 2 shows an example of autonomous retransmission. Autonomous retransmission can be triggered when the remaining time of an RLC SDU is smaller than a specified threshold. The remaining time may be remaining time until PDCP discard timer expiry or remaining time until other timer expiry. As the autonomous retransmission requires more data usage, the number of autonomous retransmissions can be limited. In an example, this number can be one per each RLC SDU. The specified threshold is configured by an RRC, Radio Resource Control, message from the base station to the UE. When an autonomous retransmission is triggered for an RLC SDU or RLC SDU segment, the transmitter considers this SDU or SDU segment for retransmission. The RLC SDU or RLC SDU segment will be retransmitted when a data resource is allocated.

Since autonomous retransmission relies on remaining time, it is possible that the initial transmission has not been performed at the triggering of autonomous retransmission. If a radio resource for the initial transmission is not allocated, the initial transmission can be delayed. In this case, autonomous retransmission is not necessary, since both the packet for the initial transmission and the packet for retransmission are pending. Then, those packets may be included in the same MAC, Medium Access Control, PDU, Protocol Data Unit. This is a duplicated transmission which wastes radio resources.

### Second Problem: Unavailability of Packet for Delivering Poll Bit Due to Unnecessary Retransmission Avoidance.

3GPP NR Release 19 (Rel-19) standards introduced a mechanism to avoid unnecessary retransmission in RLC AM. The main principle is that the transmitter does not perform a transmission nor retransmission of any outdated SDU or SDU segment any more. The receiver detects the presence of an outdated SDU based on a timer and then abandons the outdated SDU. When the transmitter entity, e.g., transmitter RLC entity, receives a discard indication of the SDU from Packet Data Convergence Protocol, PDCP (), the transmitter considers the SDU as an outdated SDU.

RLC AM has a polling procedure to request a status report to the receiver. FIG. 3 depicts an example of polling procedure. In the example procedure, a poll bit is set to 1 in an RLC header transmitted together with the packet, e.g., with the RLC SDU or the SDU segment. The polling procedure is necessary when there are only a few packets to be transmitted. Upon submission of an RLC PDU including a poll to the lower layer, the transmitter starts or restarts a timer, typically referred to as a t-PollRetransmit timer. Upon expiry of t-PollRetransmit timer, if both the transmission buffer and the retransmission buffer are empty, excluding transmitted RLC SDU or RLC SDU segment awaiting acknowledgements, or if no new RLC SDU or RLC SDU segment can be transmitted, e.g. due to window stalling, the transmitter considers an RLC SDU for retransmission. This RLC SDU may be either the RLC SDU with the highest SN among the RLC SDUs submitted to lower layer or any RLC SDU which has not been positively acknowledged. The transmitter includes a poll, e.g., a poll bit set to 1, in an RLC PDU of the chosen RLC SDU. When the receiver receives a poll, the receiver may send a status report to the transmitter.

There may be a conflict between polling and unnecessary retransmission avoidance in case there is no packet which can be considered for retransmission to include a poll. In this case, a poll cannot be transmitted. This scenario can happen when all possible RLC SDU which can be considered for retransmissions are outdated. This second problem may result in RLC window desynchronization between the transmitter and the receiver.

### Third Problem: Inability to Include Remaining Time Information in Delay Status Report.

A third problem is that for some packets remaining time information is not included in a delay status report, DSR. Such packets for which remaining time information may not be included in a delay status report include the following: PDCP control PDU, PDCP SDU to be retransmitted, PDCP data PDU to be retransmitted, RLC control PDU and RLC data PDU pending for retransmission.

FIG. 4 depicts a Delay Status Report, DSR, format as defined in 3GPP TS 38.321 V 18.3.0 (2024-09). The medium access control entity, MAC CE, format consists of Logical Channel Group, LCG, bitmap, e.g., LCGi bitmap; Remaining Time (RT) field; Buffer Size (BS) field; BT field; and reserved or R field. LCGi field indicates whether the set of the RT field and the BS field for the logical channel group, LCG, with LCG ID i is present or not. When the LCGi field is set to 1, the corresponding RT field and BS field for LCG with LCG ID i is present. When the LCGi field is set to 0, the corresponding RT field and BS field for the LCG with LCG ID i is omitted. The RT field indicates the shortest remaining value of PDCP discard timer for the corresponding LCG. The BS field indicates the total amount of delay-critical data for the corresponding LCG. The BT field indicates the buffer size table to be used in the DSR MAC CE for the LCG. The BT field is set to 0 when a normal buffer size table is used. The BT field set to 1 indicates that a refined buffer size table for XR applications. The R field is a reserved field. The RT field and the BS field are codepoints which map to ranges of remaining time and buffer size, respectively. As used herein, “buffer size” refers to the amount of contents in a buffer that is germane to an event, such as transmission of a DSR MAC CE, and not the overall capacity of a memory device in which the buffer is realized or hosted.

FIG. 5 depicts an example of a triggering event of a delay status report, DSR, and the corresponding contents of the delay status report. In the example of FIG. 5, two logical channels, LCHs, e.g. LCH1 and LCH2, are configured for a wireless terminal, UE. LCH1 belongs to a logical channel group (LCG) shown as LCG3. LCH2 belongs to a logical channel group, LCG, shown as LCG4. The example of FIG. 5 shows that a packet, pkt, of 1000 bytes for LCH1 arrives at the UE. Its PDCP discard timer starts at the arrival of the packet. If there is a packet with remaining time below the remaining time threshold, a DSR is triggered. A DSR MAC CE is transmitted when the UE receives an uplink grant to accommodate the DSR MAC CE. LCH2 has only a PDCP control PDU of 1000 bytes, which is not associated with PDCP discard timer, so the PDCP control PDU does not have its remaining time. Thus, LCH2 does not trigger a DSR. However, if a DSR MAC CE is transmitted, the amount of the PDCP control PDU can be reported as delay-critical data. In an exemplary implementation, packets such as a PDCP control PDU, a PDCP SDU to be retransmitted, a PDCP data PDU to be retransmitted, an RLC control PDU, and an RLC data PDU pending for retransmission can be reported in a DSR MAC CE.

A DSR MAC CE indicates, e.g., an LCG which has delay-critical data, the shortest remaining time among stored data for the LCG, and buffer size of delay-critical data. The buffer size of the delay-critical data is also called “delay-critical data volume”. In the example of FIG. 5, the transmitted DSR indicated that LCG3 and LCG4 have delay-critical data. That LCG3 has delay-critical data is particularly indicated by a one-bit indication, LCG3, set to 1. Similarly, LCG4 is set to 1. For other LCGs, LCGi, their corresponding one-bit indications, LCGi, are set to 0. For LCG 3, the reported remaining time, which is the shortest remaining time is y, the remaining time at the transmission time of the DSR. Buffer size is expressed as a codepoint for range of buffer size. According to 3GPP TS 38.321, 1000 bytes correspond to codepoint 74. For LCG4, buffer size is indicated as codepoint 74, which covers 1000 bytes. But the shortest remaining time does not exist, so the base station may be confused about the contents of the DSR MAC CE in case that an LCG has only a packet such as a PDCP control PDU, a PDCP SDU to be retransmitted, a PDCP data PDU to be retransmitted, a RLC control PDU, and a RLC data PDU pending for retransmission.

### Fourth Problem: Delay Status Report Without A Remaining Time Field for Certain Packets.

A fourth problem is that certain packets can be reported in a delay status report, DSR, but the DSR does not include the remaining time information for those certain packets. The certain packets include: a PDCP control PDU, a PDCP SDU to be retransmitted, a PDCP data PDU to be retransmitted, an RLC control PDU, and an RLC data PDU pending for retransmission.

FIG. 6 depicts an example of multiple-entry DSR MAC CE format for multiple zone reporting. In the Rel-19 MAC specification, a multiple-entry DSR reporting MAC CE format has been introduced to report multiple delay zones. For instance, zone 1 is data with remaining time between 0 ms and the first threshold, e.g. 10 ms, zone 2 is data with remaining time between the first threshold and the second threshold, e.g. 20 ms, zone 3 is data with remaining time between the second threshold and the third threshold, e.g. 30 ms.

The MAC CE format consists of Logical Channel Group, LCG, bitmap, e.g., LCGi bitmap; Extension field, EXT; Remaining Time, RT, field; Buffer Size, BS, field; and BT field. LCGi field indicates whether the set of the RT field and the BS field for the logical channel group, LCG, with LCG ID i is present or not. When the LCGi field is set to 1, the corresponding RT field and BS field for LCG with LCG ID i is present. When the LCGi field is set to 0, the corresponding RT field and BS field for the LCG with LCG ID i is omitted.

The RT field indicates the shortest remaining value of PDCP discard timer in each zone for the corresponding LCG. The BS field indicates the total amount of delay-critical data in each zone for the corresponding LCG. The BT field indicates the buffer size table to be used in the DSR MAC CE for the LCG. The BT field is set to 0 when a normal buffer size table is used. The BT field set to 1 indicates that a refined buffer size table for XR applications. EXT field indicates whether the next combination of BT, EXT, RT, and BS field is for the same LCG or not. EXT field set to 1 means that the next combination of BT, EXT, RT, and BS field is for a different zone of the same LCG. Otherwise, the next combination of BT, EXT, RT, and BS field is for a different LCG or is not present. The RT field and the BS field are codepoints which map to ranges of remaining time and buffer size, respectively. As used herein, “buffer size” refers to the amount of contents in a buffer that is germane to an event, such as transmission of a DSR MAC CE, and not the overall capacity of a memory device in which the buffer is realized or hosted.

Packets such as a PDCP control PDU, a PDCP SDU to be retransmitted, a PDCP data PDU to be retransmitted, an RLC control PDU, and a RLC data PDU pending for retransmission do not have a remaining time. In case of multiple zone reporting, an appropriate zone should be provided for the remaining time data.

What is needed are methods, apparatus, and/or techniques to address one or more of the foregoing problems that may be associated with packet retransmission and/or delay status reporting in wireless communications.

### SUMMARY

In the first of its example aspects the technology disclosed herein concerns a node of a wireless communications system. The node comprises at least one processor comprising processor circuitry and interface circuitry. The processor circuitry is configured to make at least three determinations. The first determination concerns a time for a packet. The second determination is whether an initial transmission of the packet has been performed. The third determination is whether to autonomously retransmit the packet. The third determination is made dependent on the first determination and the second determination. The interface circuitry is configured, in accordance with the third determination, to autonomously retransmit the packet over a radio interface to another node of the communications system. Methods of operating such nodes are also provided.

In another of its example aspects the technology disclosed herein concerns a network node of a telecommunications system. The node comprises at least one processor comprising processor circuitry and interface circuitry. The processor circuitry is configured to make a first determination that a poll retransmit timer has expired; make a second determination regarding packet availability for transmission or retransmission; and make a third determination to retransmit an outdated packet of a predetermined type in dependence upon the first determination and the second determination. The interface circuitry is configured to retransmit the outdated packet over a radio interface to another node in accordance with the third determination. Methods of operating such nodes are also provided.

In another of its example aspects the technology disclosed herein concerns a network node of a telecommunications system. The node comprises at least one processor comprising processor circuitry and interface circuitry. The processor circuitry is configured to generate a delay status report (DSR) medium access control (MAC) control element (CE) wherein in the DSR MAC CE for a zone of a logical channel group (LCG) corresponding to an entity which has only data not associated with a remaining time, a remining time (RT) field for the zone is set to a predefined value. The interface circuitry is configured to transmit the delay status report with the MAC CE over a radio interface to another node. Methods of operating such network nodes are also disclosed.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view of an example of autonomous retransmission in which autonomous retransmission may occur before an initial transmission.

FIG. 3 is a diagrammatic view of an example polling procedure.

FIG. 4 is a diagrammatic view of an example Delay Status Report, DSR.

FIG. 5 is a diagrammatic view of an example triggering event of a delay status report, DSR, and corresponding contents of an example delay status report.

FIG. 6 is a diagrammatic view of an example multiple-entry DSR MAC CE format for multiple zone reporting.

FIG. 7 is a diagrammatic view of an example communications system which addresses a problem of autonomous retransmission of a packet triggered before the initial transmission of the packet.

FIG. 8 is a diagrammatic view depicting example transmissions between a network node NN and a wireless terminal US in accordance with the example embodiment and mode of FIG. 7

FIG. 9 is a diagrammatic view of an example case of potential autonomous retransmission decision considering initial transmission status of packet which was in the form of a SDU segment.

FIG. 10 is a schematic view of an example implementation of a communications system which may be utilized to implement the scenario and acts of FIG. 7.

FIG. 11 is a diagrammatic view of an example retransmission of an outdated packet at expiry of a poll retransmit timer.

FIG. 12 is a diagrammatic view of an example communications system which retransmits an outdated packet of a predetermined type under certain conditions.

FIG. 13 is a schematic view of an example implementation of a communications system which may be utilized to implement the scenario and acts of FIG. 12.

FIG. 14 a diagrammatic view of an example communications system which generates a delay status report (DSR) medium access control in which a remining time (RT) field for the zone of a logical channel group (LCG) corresponding to one or more entities is set to a predefined value.

FIG. 15 is a diagrammatic view showing an example triggering event of a delay status report, DSR, and the corresponding contents of the delay status report in case an LCG has only data not associated with remaining time.

FIG. 16 is a diagrammatic view showing an example data volume indication and DSR contents determination for data not associated with remaining time.

FIG. 17 is a diagrammatic view showing an example of Delay Status Report contents determination in a multi-entry DSR MAC CE for an example embodiment and mode such as of FIG. 14.

FIG. 18 is a schematic view of an example implementation of a communications system which may be utilized to implement the scenario and acts of FIG. 14.

FIG. 19 is a diagrammatic view showing example elements comprising electronic machinery which may comprise a wireless terminal, a radio access node, and a core network node according to an example embodiment and mode.

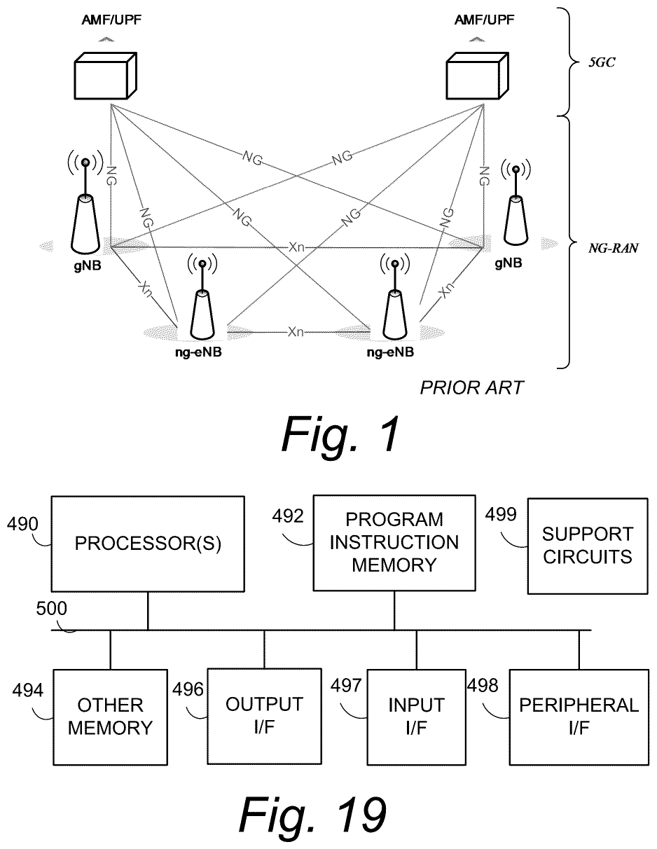

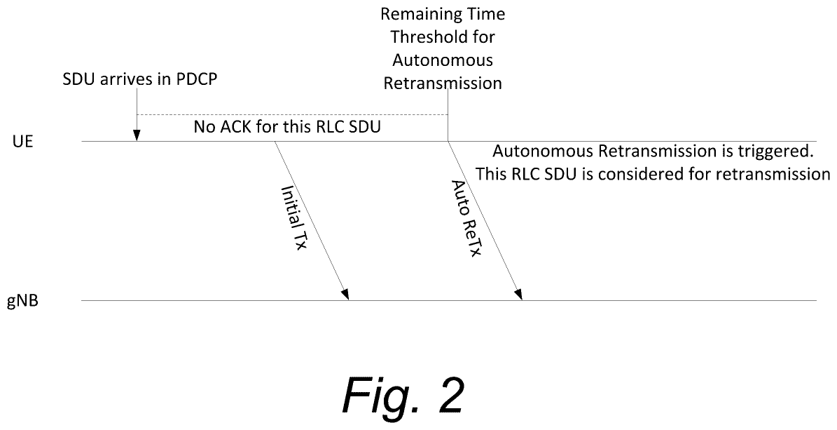

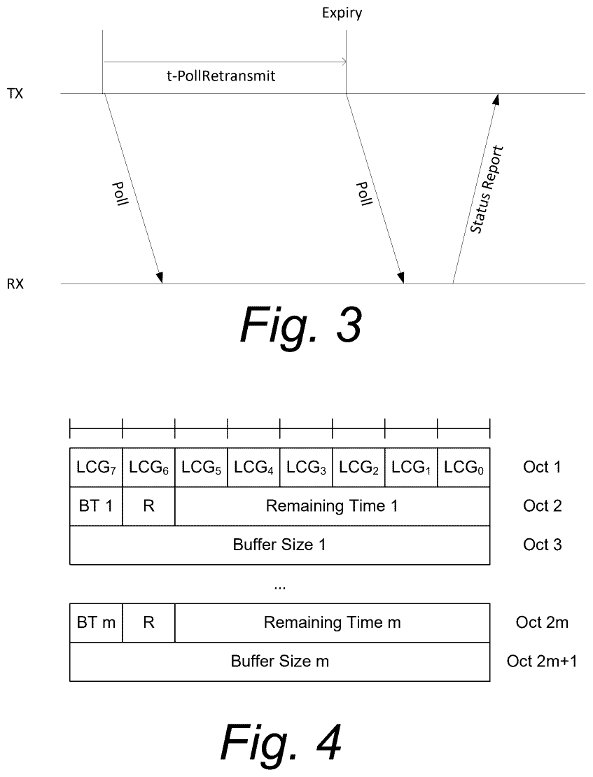

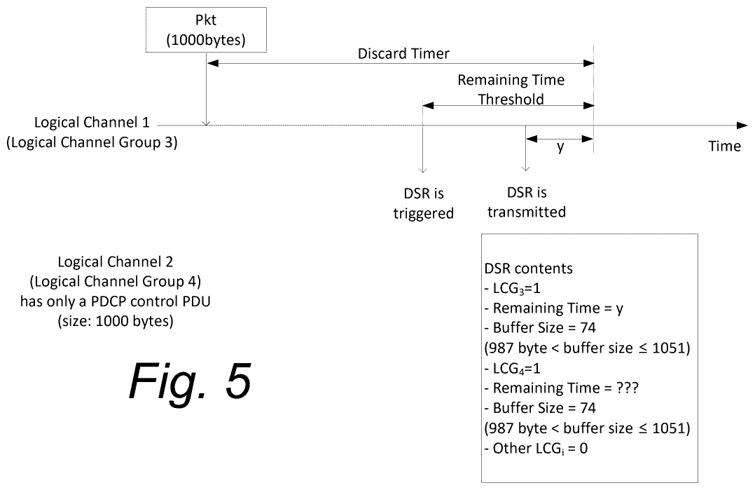

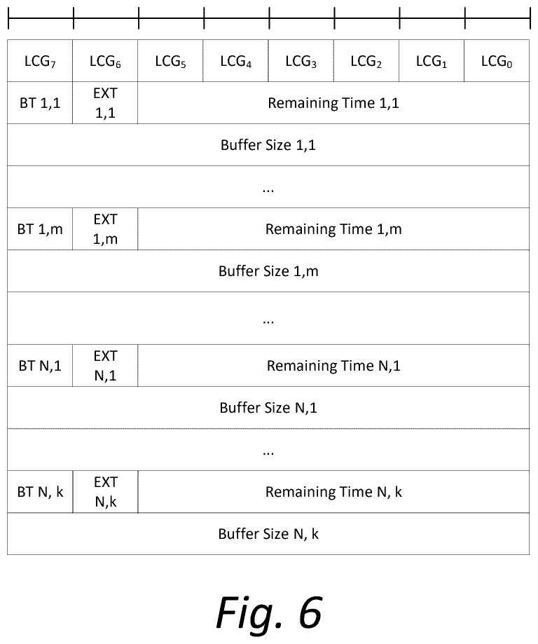

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. In some non-limiting example embodiments and modes the wireless terminal node may operate in a half-duplex frequency-division duplexing mode.

A wireless terminal communicates with its serving radio access network (RAN) over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between radio access network (RAN) 24 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k, l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having 1 ms duration similar to LTE. Each subframe consists of 2^{μ} slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

Logical channels reside between the RLC sublayer and the MAC sublayer which, as already mentioned, are layer 2 protocols in protocol stack. A Logical channel informs what kind of information is transferred. Logical channels can be broadly divided into two types: Control Channels (for the transfer of control plane information) and Traffic Channels (for the transfer of user plane information). A logical channel is eventually mapped to a physical channel.

The technology disclosed herein generally concerns and addresses one or more of the retransmission-related and/or delay status reporting problems described above. For example, in various example embodiments and modes, the example embodiments and modes disclosed herein address, individually and/or collectively the problems of (1) an autonomous retransmission triggered before the initial transmission; (2) unavailability of a packet for delivering a poll bit due to unnecessary retransmission avoidance; (3) inability to include remaining time information in a delay status report; and (4) a delay status report without a remaining time fields for certain packets. Section 1.0 hereof includes example embodiments and modes that address, e.g., the problem of (1) an autonomous retransmission triggered before the initial transmission. Section 2.0 hereof includes example embodiments and modes that address, e.g., the problem of unavailability of a packet for delivering a poll bit due to unnecessary retransmission avoidance. Section 3.0 hereof includes example embodiments and modes that address, e.g., the problems of (3) inability to include remaining time information in a delay status report; and (4) a delay status report without a remaining time fields for certain packets.

The descriptions of the example embodiments and modes of Section 1.0, Section 2.0, and Section 3.0 hereof refer to a first node or transmitter node TxN and a second node or receiver node RxN. The transmitter node TxN and the receiver node RxN both engage in transmissions and receptions with one another over an air or radio interface. The term “transmitter” is applied to the transmitter node TxN in the sense that it is the node involved or potentially involved in a retransmission operation at a particular time. In a first example scenario of operation of the example embodiments and modes of each of Section 1.0, Section 1.0, and Section 3.0 hereof, the first node or transmitter node TxN may be a wireless terminal, UE, and the second node or receiver node RxN may be a network node, such as a node of a radio access network, e.g., a base station node such as a gNB, for example. Alternatively, in another example scenario of operation of each of Section 1.0, Section 1.0, and Section 3.0 hereof, the roles of the nodes may be reversed so that the first node or transmitter node TxN may be a network node and the second node or receiver node RxN may be a wireless terminal, UE. Although various figures and descriptions herein are described with reference to the first example scenario in which the first node or transmitter node TxN is a wireless terminal, UE, such examples are not limiting and accordingly the roles may be reversed in other example scenarios.

As used herein, “packet” may comprise at least one of a radio link control (RLC) service data unit (SDU) and a segment of an RLC SDU.

### 1.0: Autonomous Retransmission Depending on Initial Transmission Status

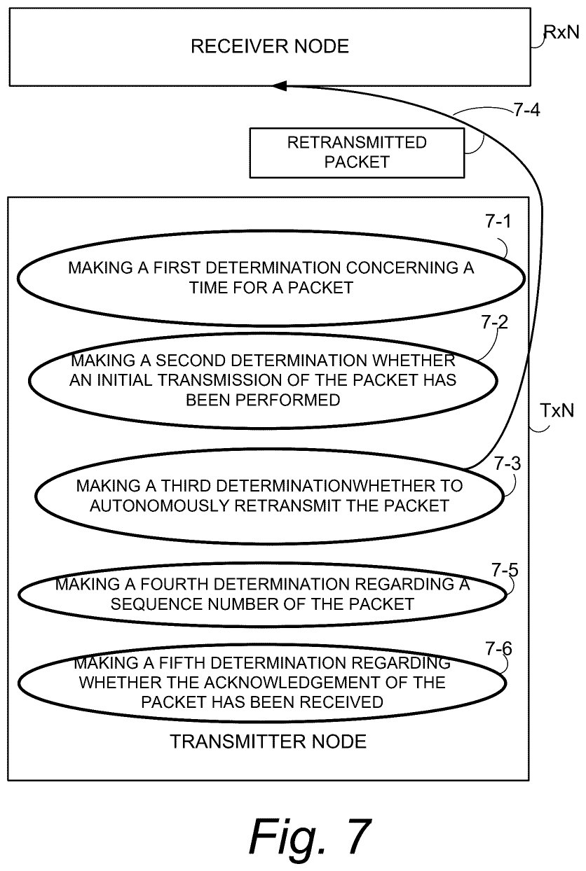

FIG. 7 illustrates an example communications system which addresses the first problem described above, the problem of an autonomous retransmission of a packet triggered before the initial transmission of the packet. For sake of simplicity, the communications system of FIG. 7 is shown as comprising a first node or transmitter node TxN and a second node or receiver node RxN. FIG. 7 particularly shows example acts that may be performed by the transmitter node TxN for addressing the problem of autonomous retransmission of the packet triggered before the initial transmission of the packet. As mentioned previously, as used herein, “packet” may comprise at least one of a radio link control (RLC) service data unit (SDU) and a segment of an RLC SDU.

Act 7-1 comprises the transmitter node TxN making a first determination concerning a time for a packet. As explained herein, the time determination for act 7-1 may be remaining timing for the packet, e.g., the timing remaining before a predetermined timer set for the packet expires.

Act 7-2 comprises the transmitter node TxN making a second determination, e.g., a determination whether an initial transmission of the packet has been performed.

Act 7-3 comprises the transmitter node TxN making a third determination, e.g., a determination whether to autonomously retransmit the packet. The third determination of act 7-3 is made in dependence upon the first determination of Act 7-1 and the second determination of act 7-2.

Act 7-4 shows the transmitter node TxN autonomously retransmitting the packet over a radio interface to a network node in accordance with the third determination, e.g., when the determination of act 7-3 indicates that autonomously retransmission should occur or is permitted to occur.

FIG. 7 also shows, by broken lines, other optional determinations that may be made by the transmitter node TxN in further example embodiments and modes. In further example embodiment and mode, act 7-5 may be performed and may serve, in addition to the determinations of act 7-1 and 7-2, as a factor in the determination of act 7-3. Act 7-5 comprises making a fourth determination, e.g., a determination regarding a sequence number of the packet. Examples of the fourth determination are provided below. In this further example embodiment and mode, each of the determinations of act 7-1, act 7-2, and act 7-5 are considered in making the determination of act 7-3.

In another further example embodiment and mode, act 7-6 may be performed and may serve, in addition to the determinations of act 7-1 and 7-2, as a factor in the determination of act 7-3. Act 7-6 comprises making a fifth determination, e.g., a determination regarding whether the acknowledgement of the packet has been received. If at act 7-6 it is determined that an acknowledgement of the packet has already been received, then the determination of act 7-3 is negative, e.g., there is no need for the transmitter node TxN to autonomously retransmit the packet.

Act 7-5 and act 7-6 may be performed in separate and distinct example embodiments and modes or may be combined in the same example embodiment and mode. When act 7-5 and act 7-6 are combined in the same example embodiment and mode, the determination of act 7-3 may be dependent on one or more, and preferably all, of act 7-1, 7-2, 7-5, and 7-6.

As explained herein, the acts of FIG. 7 may be performed, at least on part, by processor circuitry of the transmitter node TxN.

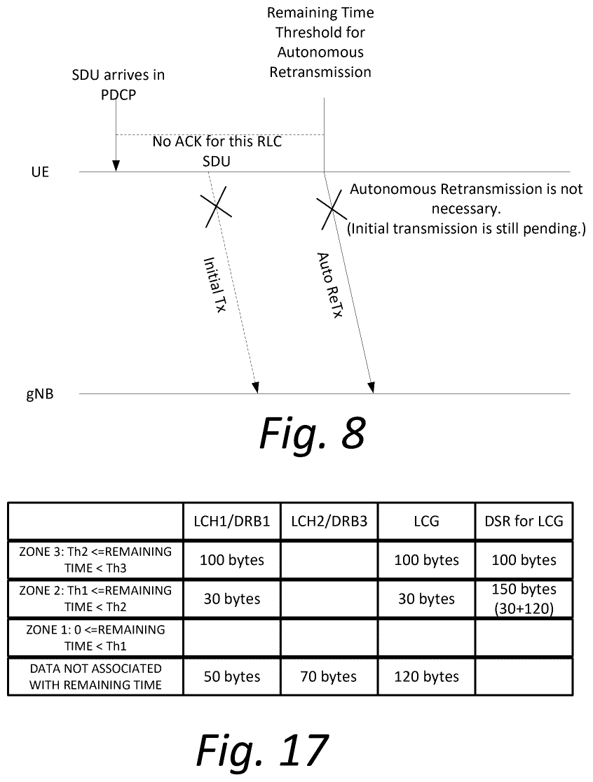

FIG. 8 depicts transmissions between a transmitter node TxN and a receiver node RxN in accordance with the example embodiment and mode of FIG. 7, and thereby shows, e.g., an autonomous retransmission decision based on, e.g., initial transmission status. As shown in FIG. 8, when a remaining time is below a configured threshold, the transmitter node TxN can check whether the initial transmission has been performed, as indicated by act 7-2. If the initial transmission has been performed, in accordance with act 7-3 of a basic example embodiment and mode, as act 7-4 the transmitter may perform the autonomous retransmission by considering the RLC SDU for retransmission.

In an exemplary and optional example embodiment and mode, if the remaining time of the SDU is below a configured threshold (as determined at act 7-1), then the transmitter, e.g., the UE, may, as act 7-5, check if the sequence number (SN) of the packet, e.g., of the SDU. Specifically, as act 7-5 the transmitter node TxN may check if SN falls within a certain range. In one example implementation, the range of the SN can be a SN smaller than or equal to the highest SN of the acknowledged mode data, AMD, PDU among the AMD PDUs submitted to lower layer, e.g., the medium access control, MAC, layer. In another example implementation, the range of the SN involved in the check of the determination of act 7-5 is a SN greater than or equal to TX_Next_ACK and smaller than or equal to the highest SN of the AMD PDU among the AMD PDUs submitted to lower layer. When the SN is within the range, retransmission of the packet, e.g., the SDU, can be considered. TX_Next_Ack is a state variable in the transmit RLC entity. This state variable holds the value of the SN of the next RLC SDU for which a positive acknowledgment is to be received in-sequence, and it serves as the lower edge of the transmitting window. It is initially set to 0, and is updated whenever the AM RLC entity receives a positive acknowledgment for an RLC SDU with SN=TX_Next_Ack. If the sequence number (SN) of the SDU falls within the range, then the transmitter node TxN considers this SDU for retransmission. If the SN of the SDU is outside of the range, the transmitter can ignore and does not perform the retransmission.

It should be understood from the foregoing that, in a basic example embodiment and mode, the transmitter node TxN checks if the initial transmission of the SDU has been already performed, as exemplified by act 7-2. If it is determined at act 7-2 that the initial transmission of the SDU is already performed, the transmitter node TxN may perform the autonomous retransmission. Otherwise, the transmitter does not perform the autonomous retransmission.

In an optional example embodiment and mode referenced with respect to act 7-6, if other determinations upon which the determination of act 7-3 may be dependent (e.g., if the remaining time of the SDU is below a configured threshold, if SN of the SDU falls within the range, or if the initial transmission of the SDU has been performed), then the transmitter node TxN can further check as act 7-6 if the transmitter node TxN has not received a positive acknowledgement for this SDU. If the transmitter node TxN has received a positive acknowledgement for this SDU, the transmitter node TxN does not perform autonomous retransmission. If the transmitter node TxN has not received a positive acknowledgement for this SDU, the transmitter node TxN may consider this SDU for retransmission.

In other words, when the transmitter node TxN determines autonomous retransmissions, the transmitter node TxN may, in accordance with the various example embodiments and modes discussed above, consider one or more of remaining time of the data (e.g., whether the remaining time is less than the threshold); the initial transmission status (e.g., whether the initial transmission has been performed or whether SN of the SDU falls within the range), and the RLC ACK status. If unnecessary transmission avoidance is configured and the SDU is considered as an outdated SDU whose discard indication was received from the upper layer, autonomous retransmission may not be performed in accordance with the example embodiments and modes of this Section 1.0.

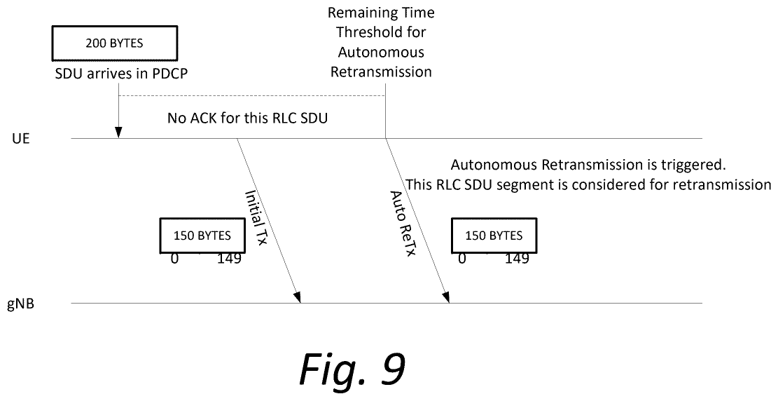

FIG. 9 depicts a case of potential autonomous retransmission decision considering initial transmission status of packet which was in the form of a SDU segment. In the illustration of FIG. 9, the UE is considered as the transmitter, e.g., the transmitter node, and a network node is considered as the receiver, e.g., the receiver node, although it should be understood that the roles may be reversed. For an RLC SDU, if the transmitter node TxN performed initial transmission of a part of an RLC SDU called SDU segment, autonomous transmission can be performed only for the SDU segment whose initial transmission has been performed. In an exemplary implementation, performing retransmission and consideration for retransmission can be exchangeable. If the remaining time of the SDU is below a configured threshold and only a part of an SDU has been transmitted, or, alternatively, has been submitted to the lower layer, the transmitter node TxN considers this SDU segment for retransmission. SDU segment which has not been transmitted, or, alternatively, has not been submitted to the lower layer is not considered for retransmission.

In the example of FIG. 9, only 150 bytes among a total of 200 bytes of the SDU are transmitted when the autonomous retransmission is triggered, e.g., when remaining time is below the remaining time threshold for autonomous retransmission. In other words, byte 0 to byte 149 were initially transmitted. The other 50 bytes are not transmitted yet. In this case, the transmitter node TxN considers only 150 bytes for retransmission and performs retransmission.

Another possible scenario is that the transmitter node TxN has received a positive acknowledgement for an SDU segment, not for the whole SDU. If the transmitter node TxN already received a positive acknowledgement for a part of an RLC SDU called SDU segment, the transmitter node TxN can perform retransmission of only SDU segment whose positive acknowledgement is not yet received. The transmitter node TxN can consider the SDU segment for retransmission.

In an exemplary implementation, when an autonomous retransmission of the SDU is triggered due to the remaining time, the SDU segment which has been transmitted and whose positive acknowledgement has not been received can be considered for retransmission by the transmitter node TxN.

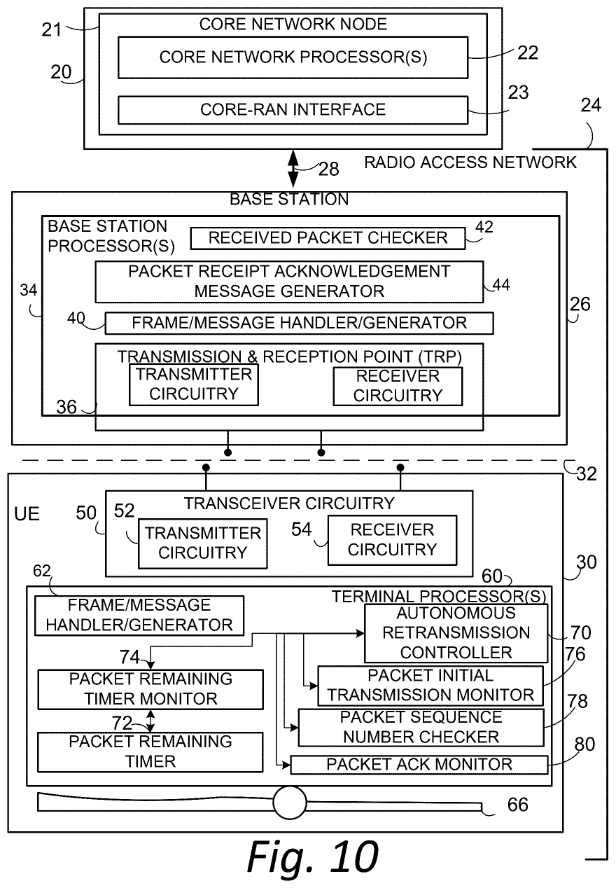

FIG. 10 shows in more detail an example implementation of a communications system which comprises a transmitter node TxN and a receiver node RxN and which may be utilized to implement the scenario and acts of FIG. 7. By way of non-limiting example, in the example implementation of FIG. 10 the receiver node RxN comprises a network node, e.g., network node 26, and the transmitter node TxN comprises a wireless terminal, UE, e.g., wireless terminal 30. Network node 26 and wireless terminal 30 communicate over a radio or air interface 32.

It should be understood that herein “network” may be used interchangeably with “network node”, except where otherwise clear from the context. Network node 28 may be either a core network node or a node of a radio access network, such as a RAN access node, e.g., a base station node, for example. In the example shown in FIG. 10, network node 26 comprises a radio access network. However, it should be understood that in other implementations and embodiments the network node NN may comprise a core network node. In example embodiments and modes in which the network node 26 is a core network node, it should be understood that the core network node communicates through a radio access node to other nodes, such as to the wireless terminal. Wireless terminal 30 may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 10 shows in example structures and functionalities that may comprise or be included in the communications network of FIG. 10. FIG. 10 shows that the example communications network, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as the example access node 26. The access node 26 serves at least one cell. The radio access network, RAN, 24 typically comprises plural access nodes, one example access node 26 being illustrated as a base station node in FIG. 10.

FIG. 10 shows the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

In the example embodiment and mode shown in FIG. 10, the base station node 26 serves as the receiver node RxN and the wireless terminal 30 serves as the transmitter node TxN. It should be understood, however, such as communications in an opposite direction, that the roles may be reversed so that the base station node 26 serves as the transmitter node TxN and the wireless terminal 30 serves as the receiver node RxN.

FIG. 10 shows base station node 26 as comprising base station processor circuitry which may comprise one or more base station processors 34, as well as base station transceiver circuitry 36. As illustrated in 10, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32. The base station processors 34 may also include received packet checker 42 and packet receipt acknowledgement message generator 44.

The base station node 26 may be structured essentially as shown in FIG. 10 or may be a node having architecture such as split architecture comprising a central unit and one or more distributed units that comprise mobile termination (MT). The base station processor(s) may include one or more TRPs.

FIG. 10 also shows various example constituent components and functionalities of wireless terminal 30. For example, FIG. 10 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 10 further shows wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise terminal user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 10 the network node is a radio access node. As mentioned above, the network node of FIG. 10 also be a core network node, such as core network node 21 of FIG. 10. FIG. 10 particularly shows that the base station processor(s) 34 of base station node 26 comprise received packet checker 42 and packet receipt acknowledgement message generator 44. In the example embodiment and mode of FIG. 10, the base station transceiver circuitry 36, under direction of base station processor(s) 34, transmits a packet acknowledgement message to the source of the received packet, e.g., to the transmitter node TxN, which, in the case of FIG. 10, is wireless terminal 30.

Wireless terminal 30 of FIG. 10 may perform the acts 7-1 through and including 7-6 of FIG. 7. In particular the wireless terminal processor(s) 60 may be involved in performing the acts of FIG. 7. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including autonomous retransmission controller 70 which performs the determination of act 7-3; packet remaining timer 72; packet remaining timer monitor 74 which is consulted by autonomous retransmission controller 70 in the determination of act 7-1; packet initial transmission monitor 76 which is consulted by autonomous retransmission controller 70 in the determination of act 7-2. Optionally, as shown by broken lines, the wireless terminal processor(s) 60 may comprise packet sequence number checker 78 which is optionally consulted by autonomous retransmission controller 70 in the determination of optional act 7-5 and/or packet acknowledgement monitor 80 which is optionally consulted by autonomous retransmission controller 70 in the determination of optional act 7-6.

In the example embodiment and mode of FIG. 10, the terminal transmitter circuitry 52 may be utilized by wireless terminal 30 in execution of act 7-4, e.g., the transmitter node TxN autonomously retransmitting the packet over a radio interface to a network node in accordance with the third determination, e.g., when the determination of act 7-3 indicates that autonomously retransmission should occur or is permitted to occur.

### 2.0: Retransmission of Outdated SDUs at Expiry of T-Poll Retransmit

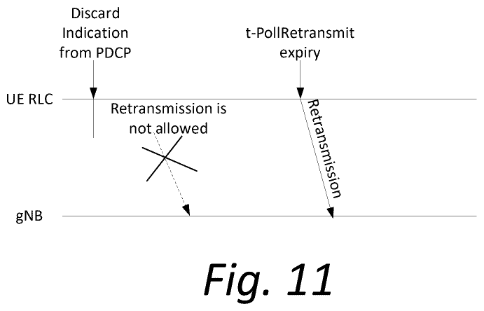

As mentioned above, a second problem may arise from unavailability of a packet for delivering a poll bit due to unnecessary retransmission avoidance. This second problem may result in RLC window desynchronization between the transmitter and the receiver. FIG. 11 depicts an example of retransmission of an outdated packet, e.g., an outdated SDU, at expiry of t-PollRetransmit timer. When the transmitting side of an RLC entity receives a discard indication of an RLC SDU from the upper layer, i.e. PDCP, the transmitter considers it as an outdated SDU. The transmitter stops transmission and retransmission of the outdated SDU.

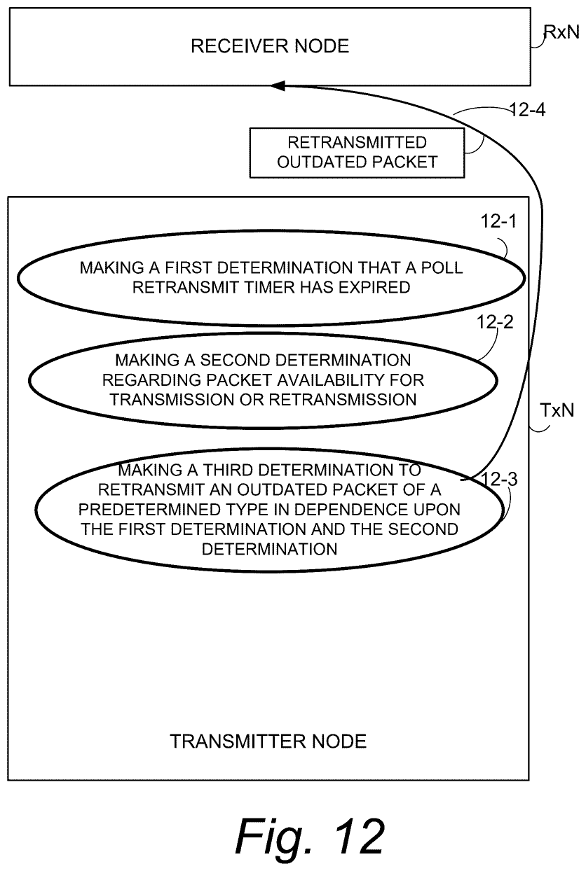

In accordance with the technology of Section 2.0 hereof, an exceptional case a retransmission of the SDU to send a poll bit to the receiver is allowed at expiration of a poll retransmit timer, e.g., a timer which may be also referred to as a t-PollRetransmit timer. FIG. 12 is an example communications system which addresses the second problem, and accordingly which retransmits an outdated packet of a predetermined type under certain conditions. For sake of simplicity, the communications system of FIG. 12 is shown as comprising a first node or transmitter node TxN and a second node or receiver node RxN. FIG. 12 particularly shows example acts that may be performed by the transmitter node TxN for addressing the problem of unavailability of a packet for delivering a poll bit due to unnecessary retransmission avoidance. As mentioned previously, as used herein, “packet” may comprise at least one of a radio link control (RLC) service data unit (SDU) and a segment of an RLC SDU.

Act 12-1 comprises the transmitter node TxN making a first determination that a poll retransmit timer has expired.

Act 12-2 comprises the transmitter node TxN making a second determination regarding packet availability for transmission or retransmission. The wherein the second determination of Act 12-2 may comprise performing at least one of the acts of (1) determining that both the transmission buffer and the retransmission buffer are empty; and (2) determining that no new packet can be transmitted.

Act 12-3 comprises the transmitter node TxN making a third determination to retransmit an outdated packet of a predetermined type in dependence upon the first determination and the second determination. The outdated packet of a predetermined type may comprises either (1) a radio link control (RLC) service data unit (SDU) with a highest sequence number (SN) among the RLC SDSs submitted to a lower layer for retransmission, or (2) a radio link control (RLC) service data unit (SDU) which has not been positively acknowledged for retransmission.

Act 12-4 comprises the transmitter node TxN retransmit the outdated packet over a radio interface to another node in accordance with the third determination.

Further to the foregoing, in the example embodiment and mode of FIG. 12, if both the transmission buffer and the retransmission buffer are empty, excluding transmitted RLC SDU or RLC SDU segment awaiting acknowledgements, or if no new RLC SDU or RLC SDU segment can be transmitted (e.g. due to window stalling), the transmitter node TxN can consider one of the following RLC SDU for retransmission:
The RLC SDU with the highest SN among the RLC SDUs submitted to lower layer for retransmission; or
Any RLC SDU which has not been positively acknowledged for retransmission.

When the transmitter node TxN performs the retransmission of the outdated packet at act 12-4, a poll is included in an RLC PDU to be transmitted, e.g., in the outdated packet.

In an exemplary implementation, for retransmission, the transmitter can consider an RLC SDU which is not outdated for retransmission, e.g., non-outdated packet, also referred to as a currently dated packet. If not, at expiration of the poll retransmit timer it is still preferable to retransmit a packet. If there are no non-outdated RLC SDUs which can be considered for retransmission, the transmitter can consider outdated RLC SDU for retransmission. If there are no outdated RLC SDUs which meet the conditions above, polling is not possible.

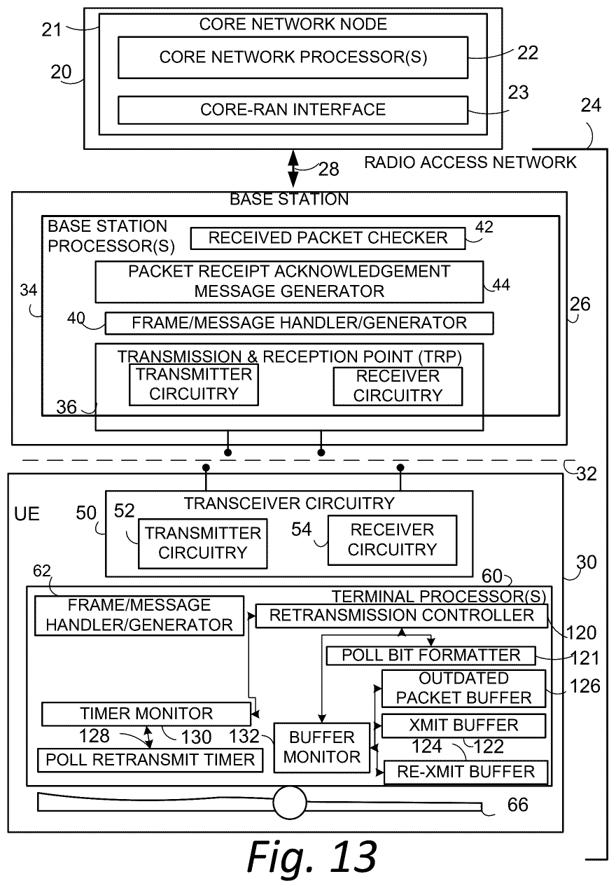

FIG. 13 shows in more detail an example implementation of a communications system which comprises a transmitter node TxN and a receiver node RxN and which may be utilized to implement the scenario and acts of FIG. 12. By way of non-limiting example, in the example implementation of FIG. 13 the receiver node RxN comprises a network node, e.g., network node 26, and the transmitter node TxN comprises a wireless terminal, UE, e.g., wireless terminal 30. Network node 26 and wireless terminal 30 communicate over a radio or air interface 32.

It should be understood that herein “network” may be used interchangeably with “network node”, except where otherwise clear from the context. Network node 28 may be either a core network node or a node of a radio access network, such as a RAN access node, e.g., a base station node, for example. In the example shown in FIG. 13, network node 26 comprises a radio access network. However, it should be understood that in other implementations and embodiments the network node NN may comprise a core network node. In example embodiments and modes in which the network node 26 is a core network node, it should be understood that the core network node communicates through a radio access node to other nodes, such as to the wireless terminal. Wireless terminal 30 may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 13 shows in example structures and functionalities that may comprise or be included in the communications network of FIG. 13. FIG. 13 shows that the example communications network, which may be 5G networks, for example, comprise core network 20. The core network 20 may comprise one or more core network nodes, such as core network node 21. Core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. Core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as the example access node 26. The access node 26 serves at least one cell. The radio access network, RAN, 24 typically comprises plural access nodes, one example access node 26 being illustrated as a base station node in FIG. 13.

FIG. 13 shows the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for simplicity, it being understood that other wireless terminals may be provided and may operate in similar manner as the wireless terminal 30 herein illustrated.

In the example embodiment and mode shown in FIG. 13, the base station node 26 serves as the receiver node RxN and the wireless terminal 30 serves as the transmitter node TxN. It should be understood, however, such as communications in an opposite direction, that the roles may be reversed so that the base station node 26 serves as the transmitter node TxN and the wireless terminal 30 serves as the receiver node RxN.

FIG. 13 shows base station node 26 as comprising base station processor circuitry which may comprise one or more base station processors 34, as well as base station transceiver circuitry 36. As illustrated in 10, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32. The base station processors 34 may also include received packet checker 42 and packet receipt acknowledgement message generator 44.

The base station node 26 may be structured essentially as shown in FIG. 13 or may be a node having architecture such as split architecture comprising a central unit and one or more distributed units that comprise mobile termination (MT). The base station processor(s) may include one or more TRPs.

FIG. 13 also shows various example constituent components and functionalities of wireless terminal 30. For example, FIG. 13 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 13 further shows wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise terminal user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 13 the network node is a radio access node. As mentioned above, the network node of FIG. 13 also be a core network node, such as core network node 21 of FIG. 13. FIG. 13 particularly shows that the base station processor(s) 34 of base station node 26 comprise received packet checker 42 and packet receipt acknowledgement message generator 44. In the example embodiment and mode of FIG. 13, the base station transceiver circuitry 36, under direction of base station processor(s) 34, transmits a packet acknowledgement message to the source of the received packet, e.g., to the transmitter node TxN, which, in the case of FIG. 13, is wireless terminal 30.

Wireless terminal 30 of FIG. 13 may perform the acts 12-1 through and including 12-4 of FIG. 12. In particular the wireless terminal processor(s) 60 may be involved in performing the acts of FIG. 12. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including retransmission controller 120 which performs the determination of act 12-3, e.g., whether to retransmit an outdated packet; packet retransmission formatter 121, also known as poll bit formatter 121, which may include a poll bit in an outdated packet which is retransmitted by retransmission controller 120; transmission buffer 122; retransmission buffer 124; outdated packet buffer 126; poll retransmit timer 128, e.g., t-PollRetransmit, poll retransmit timer monitor 130 which is consulted by retransmission controller 120 in the determination of act 12-1; and buffer monitor 132 which may be consulted by retransmission controller 120 in the determination of act 12-2.

In the example embodiment and mode of FIG. 13, the terminal transmitter circuitry 52 may be utilized by wireless terminal 30 in execution of act 12-4, e.g., the transmitter node TxN retransmitting the outdated packet over a radio interface 32 to a network node in accordance with the third determination, e.g., when the determination of act 12-3 indicates that retransmission should occur or is permitted to occur.

### 3.0: Delay Status Reporting for Data Not Associated With Remaining Time

As mentioned above, third and fourth problems may arise from inability to include remaining time information in a delay status report; and (4) a delay status report without a remaining time fields for certain packets.

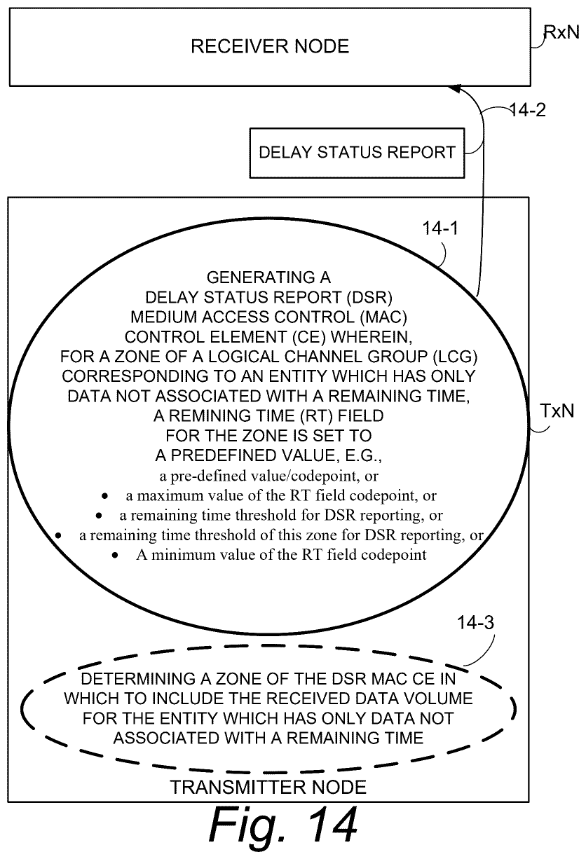

In accordance with the technology of Section 3.0 hereof, FIG. 14 is an example communications system which addresses the one or both of the third and fourth problems, and accordingly which generates a delay status report (DSR) medium access control (MAC) control element (CE) in which, for a zone of a logical channel group (LCG) corresponding to an entity which has only data not associated with a remaining time, a remining time (RT) field for the zone is set to a predefined value. That is FIG. 14 shows an example communications system which generates a delay status report (DSR) medium access control in which a remining time (RT) field for the zone of a logical channel group (LCG) corresponding to one or more entities is set to a predefined value. The entity for which the RT field is set to a predetermined value is an entity which has only data not associated with a remaining time, as explained above.

For sake of simplicity, the communications system of FIG. 14 is shown as comprising a first node or transmitter node TxN and a second node or receiver node RxN. FIG. 14 particularly shows example acts that may be performed by the transmitter node TxN for addressing the third and/or fourth problems. As mentioned previously, as used herein, “packet” may comprise at least one of a radio link control (RLC) service data unit (SDU) and a segment of an RLC SDU.

Act 14-1 comprises the transmitter node TxN generating a delay status report (DSR) medium access control (MAC) control element (CE) wherein, for a zone of a logical channel group (LCG) corresponding to an entity which has only data not associated with a remaining time, a remining time (RT) field for the zone is set to a predefined value. Act 14-2 comprises the transmitter node TxN transmitting the delay status report with the MAC CE which was generated as act 14-1 over a radio interface to another node.

FIG. 14 further shows that the predefined value may be one or more of a pre-defined value/codepoint; a maximum value of the RT field codepoint; a remaining time threshold for DSR reporting; a remaining time threshold of this zone for DSR reporting; and a minimum value of the RT field codepoint.

FIG. 14 also illustrates by broken lines an optional further act 14-3. Act 14-3 may be performed for a multi-zone DSR when a data volume for an entity, which has only data not associated with a remaining time, is received from at least one of a radio link control (RLC) layer and a packet data convergence protocol (PDCP) layer, the received data volume when received not being associated with zone of the DST MAC CE upon receipt. Act 14-3 comprises determining a zone of the DSR MAC CE in which to include the received data volume for the entity which has only data not associated with a remaining time. For example, the transmitter node TxN may determine the zone of the DSR MAC CE in which to include the received data volume for the entity which has only data not associated with a remaining time as a zone associated with a smallest threshold among which delay information is reported.

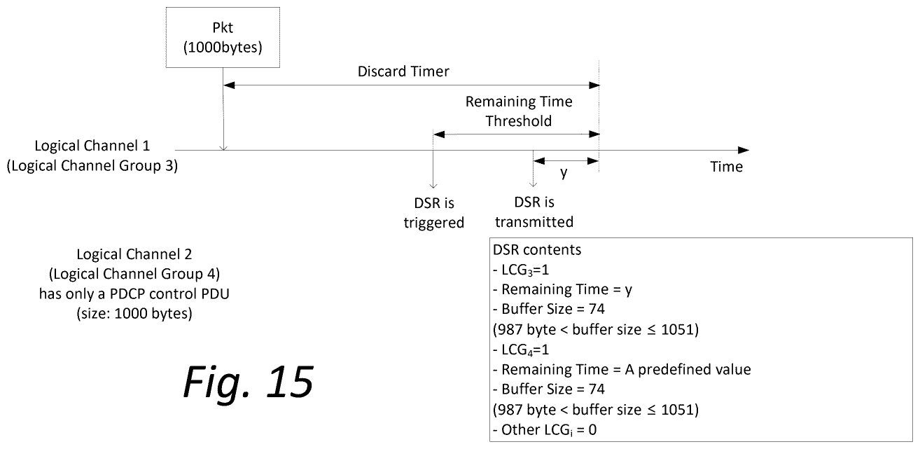

FIG. 15 depicts an example of a triggering event of a delay status report, DSR, and the corresponding contents of the delay status report in case an LCG has only data not associated with remaining time. Data not associated with remaining time can be any packet which does not have its own PDCP discard timer. Data not associated with remaining time, e.g., an entity which has only data not associated with a remaining time, may comprise or be at least one of PDCP control PDU, PDCP SDU to be retransmitted, PDCP data PDU to be retransmitted, RLC control PDU and RLC data PDU pending for retransmission. Such entity may also be referred to herein as a “time unassociated entity”. If an LCG has only PDCP control PDU, PDCP SDU to be retransmitted, PDCP data PDU to be retransmitted, RLC control PDU and RLC data PDU pending for retransmission, which can be included in the DSR, then its RT field can be set to a pre-defined value/codepoint to indicate that this LCG has only data not associated with remaining time. In multiple-entry DSR, if a zone for an LCG has only data not associated with remaining time, i.e. PDCP control PDU, PDCP SDU to be retransmitted, PDCP data PDU to be retransmitted, RLC control PDU and RLC data PDU pending for retransmission, then its RT field for this zone can be set to a pre-defined value/codepoint to indicate that this zone has only data not associated with remaining time. As a special case, DSR MAC CE in Rel-18 is considered as a multiple-entry MAC CE with a single zone. The pre-defined value can be the maximum value of the RT field codepoint. In another exemplary implementation, the pre-defined value can be the remaining time threshold for DSR reporting. In multiple-entry DSR, the pre-defined value can be the remaining time threshold of this zone for DSR reporting. In another exemplary implementation, the pre-defined value can be the minimum value of the RT field codepoint.

In the example of FIG. 15, two logical channels, LCHs, e.g. LCH1 and LCH2 are configured for a UE. LCH1 belongs to a logical channel group (LCG) shown as LCG3. LCH 2 belongs to LCG shown as LCG4. The example of FIG. 15 shows that a packet (pkt) of 1000 bytes for LCH1 arrives at the UE. Its PDCP discard timer starts at the arrival of the packet. If there is a packet with remaining time below the remaining time threshold, a DSR is triggered. A DSR MAC CE is transmitted when the UE receives an uplink grant to accommodate the DSR MAC CE. LCH2 has only PDCP control PDU of 1000 bytes, which is not associated with PDCP discard timer, so the PDCP control PDU does not have its remaining time. Thus, LCH2 does not trigger a DSR. However, if a DSR MAC CE is transmitted, the amount of PDCP control PDU can be reported as delay-critical data. In an exemplary implementation, at least one of PDCP control PDU, PDCP SDU to be retransmitted, PDCP data PDU to be retransmitted, RLC control PDU and RLC data PDU pending for retransmission can be reported in a DSR MAC CE.

A DSR MAC CE indicates, e.g., an LCG which has delay-critical data, the shortest remaining time among stored data for the LCG, and buffer size of delay-critical data. The buffer size of the delay-critical data is also called “delay-critical data volume”. In the example of FIG. 15, the transmitted DSR indicated that LCG3 and LCG4 have delay-critical data. That LCG3 has delay-critical data is particularly indicated by a one-bit indication, LCG3, set to 1. Similarly, LCG4 is set to 1. For other LCGs, LCGi, their corresponding one-bit indications, LCGi, are set to 0. For LCG 3, the reported remaining time, which is the shortest remaining time is y, the remaining time at the transmission time of the DSR. Buffer size is expressed as a codepoint for range of buffer size. According to 3GPP TS 38.321, 1000 bytes correspond to codepoint 74. For LCG4, buffer size is indicated as codepoint 74, which covers 1000 bytes. The RT field is set to a pre-defined value used when there is no data associated with the remaining time.

In an exemplary implementation, if an LCG has only PDCP control PDU, PDCP SDU to be retransmitted, PDCP data PDU to be retransmitted, RLC control PDU and RLC data PDU pending for retransmission, which can be included in the DSR, then a DSR MAC does not include any delay information for this LCG. In the example of FIG. 15, LCG4 information is not included in the DSR, and LCG4 field is set to 0. In other words, if an LCG has delay-critical data whose remaining time is below a reporting threshold for the LCG, the delay information of the LCG is reported in the DSR MAC CE.

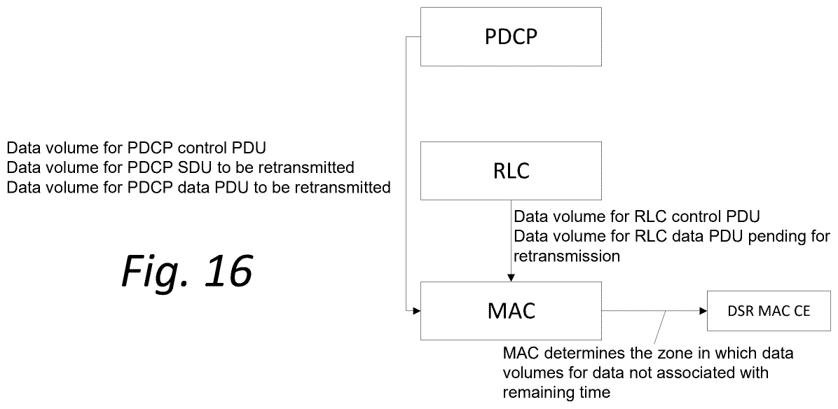

FIG. 16 depicts data volume indication and DSR contents determination for data not associated with remaining time. If an LCG is configured with multiple zones of DSR, both PDCP and RLC provide data volume associated with each zone to the MAC entity. If a packet is associated with remaining time regardless of SDU or PDU, PDCP or RLC can determine whether to include the data volume for the packet as a content of the DSR. On the contrary, if data is not associated with remaining time, PDCP and RLC do not determine the zone which includes the data volume for the data not associated with remaining time. Data not associated with remaining time can be one of PDCP control PDU, PDCP SDU to be retransmitted, PDCP data PDU to be retransmitted, RLC control PDU and RLC data PDU pending for retransmission.

For those data not associated with remaining time, PDCP and RLC can send information on the amount of such data to MAC. More specifically, PDCP sends data volume for at least one of PDCP control PDU, data volume for PDCP SDU to be retransmitted, and data volume for PDCP data PDU to be transmitted, to MAC. RLC sends data volume for at least one of RLC control PDU and data volume for RLC data PDU pending for retransmission. These data volumes are not associated with any zone in the DSR when PDCP and RLC send them. An LCG may consist of multiple logical channels. The MAC entity may merge the received information for multiple logical channels. The MAC entity can determine the zone which includes the received data volume for data not associated with remaining time. In an exemplary implementation, the received data volume for data not associated with remaining time can be included in the zone associated with the smallest threshold among which delay information is reported.

FIG. 17 depicts an example of DSR contents determination in a multi-entry DSR MAC CE. In the example, two logical channels, namely, LCH1 and LCH2, are configured for an LCG. Also, three zones with three remaining time thresholds are configured. LCH1 and LCH2 in MAC/RLC correspond to Data Radio Bearer 1, DRB1 and Data Radio Bearer 2, DRB2, respectively. LCH1/DRB1 has 30 bytes of data associated with a remaining time for zone 2 and 100 bytes of data associated with remaining time for zone 3. LCH 1/DRB1 has 50 bytes of data not associated with remaining time. LCH2/DRB2 does not have any data associated with remaining time to be reported in the DSR. LCH2/DRB2 has 70 bytes of data not associated with remaining time. Those are provided from PDCP and RLC to MAC.

MAC merges data volumes of LCH1/DRB1 and LCH2/DRB2 into data volume for the LCG. Data volume for zone 2 is 30 bytes and data volume for zone 3 is 100 bytes. Data volume for data not associated with remaining time is 120 bytes.

In the example of FIG. 17, zone 1 for the LCG does not have any data. The delay information for zone 1 is not reported in the DSR for the LCG. Data volume for data not associated with remaining time is included in the zone associated with the smallest threshold among which delay information is reported. Zone 2 is the zone associated with the smallest threshold among which delay information is reported. Thus, 120 bytes which is the data volume for data not associated with remaining time are merged into data volume for zone 2 (30 bytes). As a result, 150 bytes are reported as buffer size of zone 2 for the LCG.

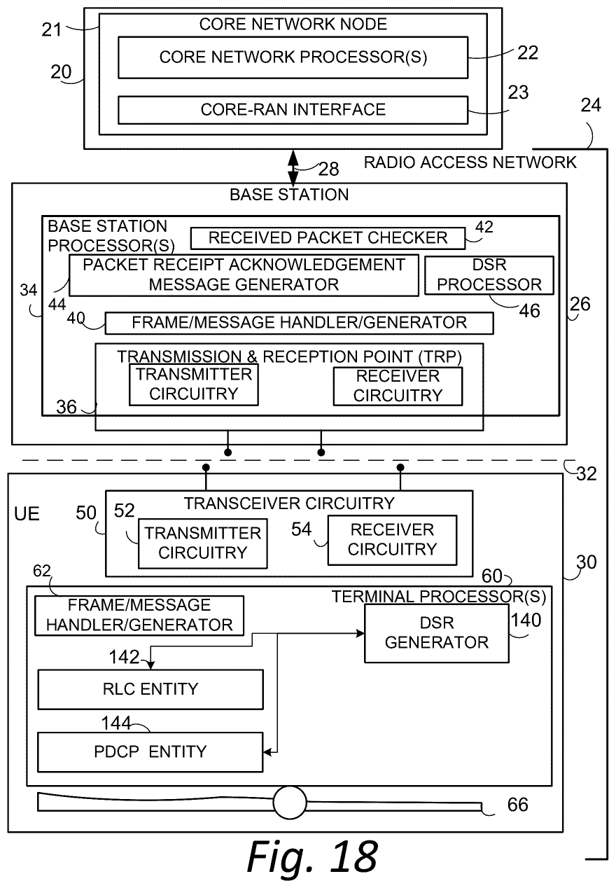

FIG. 18 shows in more detail an example implementation of a communications system which comprises a transmitter node TxN and a receiver node RxN and which may be utilized to implement the scenario and acts of FIG. 14. By way of non-limiting example, in the example implementation of FIG. 18 the receiver node RxN comprises a network node, e.g., network node 26, and the transmitter node TxN comprises a wireless terminal, UE, e.g., wireless terminal 30. Network node 26 and wireless terminal 30 communicate over a radio or air interface 32.

It should be understood that herein “network” may be used interchangeably with “network node”, except where otherwise clear from the context. Network node 28 may be either a core network node or a node of a radio access network, such as a RAN access node, e.g., a base station node, for example. In the example shown in FIG. 18, network node 26 comprises a radio access network. However, it should be understood that in other implementations and embodiments the network node NN may comprise a core network node. In example embodiments and modes in which the network node 26 is a core network node, it should be understood that the core network node communicates through a radio access node to other nodes, such as to the wireless terminal. Wireless terminal 30 may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 18 shows in example structures and functionalities that may comprise or be included in the communications network of FIG. 18. FIG. 18 shows that the example communications network, which may be 5G networks, for example, comprise core network 20. The core network 20 may comprise one or more core network nodes, such as core network node 21. Core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. Core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as the example access node 26. The access node 26 serves at least one cell. The radio access network, RAN, 24 typically comprises plural access nodes, one example access node 26 being illustrated as a base station node in FIG. 18.

FIG. 18 shows the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for simplicity, it being understood that other wireless terminals may be provided and may operate in similar manner as the wireless terminal 30 herein illustrated.

In the example embodiment and mode shown in FIG. 18, the base station node 26 serves as the receiver node RxN and the wireless terminal 30 serves as the transmitter node TxN. It should be understood, however, such as communications in an opposite direction, that the roles may be reversed so that the base station node 26 serves as the transmitter node TxN and the wireless terminal 30 serves as the receiver node RxN.

FIG. 18 shows base station node 26 as comprising base station processor circuitry which may comprise one or more base station processors 34, as well as base station transceiver circuitry 36. As illustrated in 10, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32. The base station processors 34 may also include received packet checker 42, packet receipt acknowledgement message generator 44, and delay status report processor 46.

The base station node 26 may be structured essentially as shown in FIG. 18 or may be a node having architecture such as split architecture comprising a central unit and one or more distributed units that comprise mobile termination (MT). The base station processor(s) may include one or more TRPs.

FIG. 18 also shows various example constituent components and functionalities of wireless terminal 30. For example, FIG. 18 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 18 further shows wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise terminal user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 18 the network node is a radio access node. As mentioned above, the network node of FIG. 18 may also be a core network node, such as core network node 21 of FIG. 18.

Wireless terminal 30 of FIG. 18 may perform the acts 14-1 through and including 14-4 of FIG. 12. In particular the wireless terminal processor(s) 60 may be involved in performing the acts of FIG. 12. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including delay status report (DSR) generator 140. As indicated above and shown by act 14-1, the delay status report (DSR) generator 140 serves, e.g., to generate a delay status report (DSR) medium access control (MAC) control element (CE). For the case shown in FIG. 14, in the DSR MAC CE generated by delay status report (DSR) generator 140, for a zone of a logical channel group (LCG) corresponding to an entity which has only data not associated with a remaining time, a remining time (RT) field for the zone is set to a predefined value. As further shown in FIG. 18, the delay status report (DSR) generator 140 may receive data volume for the entity which has only data not associated with a remaining time from at least one of a radio link control (RLC) layer entity 142 and a packet data convergence protocol (PDCP) entity 144. The received data volume when received not being associated with a zone of the DST MAC CE. Upon receiving the data volume for the entity which has only data not associated with a remaining time, the delay status report (DSR) generator 140 may determine a zone of the DSR MAC CE in which to include the received data volume for the entity which has only data not associated with a remaining time.

In the example embodiment and mode of FIG. 18, the terminal transmitter circuitry 52 may be utilized by wireless terminal 30 in execution of act 14-2, e.g., to transmit the delay status report with the MAC CE over a radio interface to another node.

### 4.0 Further Considerations

The outlined captions hereof are not technically limiting but only for textual organizational.

For the foregoing example embodiments and modes, units and functionalities of any example embodiment and mode which have the same reference numbers of other example embodiments and modes should be understood to be the same as structure and operation even if not discussed in the context of the example embodiment and mode, unless otherwise clear from the context.

As mentioned above, aspects of one or more of the various example embodiments and modes may be used in combination with one or more example embodiments and modes. For example, one or more of the example embodiments and modes hereof may be used in combination with one or more of the example embodiments and modes. Moreover, while some of the illustrations for the various example embodiments and modes of are shown as including structures, features, or acts of other example embodiments and modes, it should be understood that in some cases not all such structures, features, or acts of preceding and/or other example embodiments and modes need necessarily be included in order to accomplish the objectives of the discussed example embodiment and mode.

Each of the example embodiments and modes discussed herein encompass a computer program product in which processor circuitry or the like, such as wireless terminal processor(s) 60 and network node processors 34, execute instructions stored on a non-transient memory to perform acts such as those above described.

In terms of wireless communication, the wireless terminal 30 may be either a wireless terminal such as user equipment or mobile station, or a network node. Similarly and conversely, the network node 26 may be either a wireless terminal such as user equipment or mobile station, or a network node. It should be understood that herein “network” may be used interchangeably with “network node”. A network node may be either a core network node or a node of a radio access network, such as a RAN access node, e.g., a base station node, for example. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

A core network may comprise one or more core network nodes. A core network node may comprise or be realized by any suitable type of core network node entities, such as a core network management entity, e.g., an Access and Mobility Management Function (AMF). A core network and one or more of its constituent core network nodes is connected to at least one radio access network through a core-RAN interface circuit.

A radio access network in turn comprises one or more radio access network (RAN) nodes, such as a base station node. The base station node serves at least one cell. The radio access network, RAN, typically comprises plural access nodes. A base station node may have architecture such as split architecture comprising a central unit and one or more distributed units that comprise mobile termination (MT).

It should be understood that the various foregoing example embodiments and modes may be utilized in conjunction with one or more example embodiments and modes described herein. For example, the example embodiments and modes of all aspects of the technology disclosed herein, may be utilized in combination with one or more other example embodiments and modes disclosed herein.

Certain units and functionalities of the communications systems may be implemented by electronic machinery. For example, electronic machinery may refer to the processor circuitry described herein, such as network node processors 34 and wireless terminal processor(s) 60. Moreover, the term “processor circuitry” is not limited to mean one processor, but may include plural processors, with the plural processors operating at one or more sites, and with the at least one processor, e.g., plural processors, operating independently and/or concurrently. Moreover, as used herein the term “server” is not confined to one server unit but may encompass plural servers and/or other electronic equipment and may be co-located at one site or distributed to different sites.

The foregoing are not exhaustive lists as other units and functionalities may also be implemented by processor circuitry.

With these understandings, FIG. 19 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, network node processors 34 and wireless terminal processor(s) 60.

A memory or register described herein may be depicted by memory 494, or any computer-readable medium, may be one or more of readily available memory such as random-access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein may be performed by a software program product stored tangibly on a non-transient computer-readable medium which, when executed by one or more processors as herein mentioned, performs such acts either in whole or in part.

Moreover, each functional block or various features of the wireless terminal 30 and network node 26 employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves, e.g., interference in a communications system.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A node of a wireless communications system, the node comprising:
at least one processor, comprising processor circuitry, configured individually and/or collectively to:
make a first determination that a poll retransmit timer has expired;
make a second determination regarding packet availability for transmission or retransmission;
make a third determination to retransmit an outdated packet of a predetermined type in dependence upon the first determination and the second determination;
interface circuitry configured to retransmit the outdated packet over a radio interface to another node in accordance with the third determination.

2. The node of claim 1, wherein the outdated packet comprises a packet for which a discard indication has been received from an upper layer.

3. The node of claim 1, wherein the outdated packet of a predetermined type comprises a radio link control (RLC) service data unit (SDU) with a highest sequence number (SN) among the RLC SDSs submitted to a lower layer for retransmission.

4. The node of claim 1, wherein the outdated packet of a predetermined type comprises a radio link control (RLC) service data unit (SDU) which has not been positively acknowledged for retransmission.

5. The node of claim 1, wherein the node further comprises a transmission buffer for a packet awaiting transmission and a retransmission buffer for a packet awaiting retransmission, and wherein the second determination comprises the at least one processor performing at least one of the acts of:
determining that both the transmission buffer and the retransmission buffer are empty;
determining that no new packet can be transmitted.

6. The node of claim 1, wherein in making the second determination that the retransmission buffer is empty the at least one processor excludes consideration of a transmitted packet awaiting an acknowledgement.

7. The node of claim 1, wherein in making the second determination that the retransmission buffer is empty the at least one processor excludes consideration of a transmitted packet awaiting an acknowledgement.

8. The node of claim 1, wherein the packet comprises at least one of a radio link control (RLC) service data unit (SDU) or a segment of an RLC SDU.

9. A method of operating a node of a communications system, the method comprising:
using at least one processor, comprising processing circuitry, to make:
a first determination that a poll retransmit timer has expired;
a second determination regarding packet availability for transmission or retransmission;
a third determination to retransmit an outdated packet of a predetermined type in dependence upon the first determination and the second determination;
retransmitting the outdated packet over a radio interface to another node in accordance with the third determination.
